(19) United States
(12) Patent Application Publication
(10) Pub. No.: US 2016/0334171 A1
(43) Pub. Date: Nov. 17, 2016

(54) HEAT DISSIPATION DEVICE AND METHOD OF MANUFACTURING THE SAME

(71) Applicants: FURUI PRECISE COMPONENT (KUNSHAN) CO., LTD., Kunshan (CN); FOXCONN TECHNOLOGY CO., LTD., New Taipei (TW)

(72) Inventors: WEI-HSIANG CHANG, New Taipei (TW); XI-YUAN SHEN, Kunshan (CN)

(21) Appl. No.: 14/811,979

(22) Filed: Jul. 29, 2015

(30) Foreign Application Priority Data
May 15, 2015 (CN) 201510247674.6

(51) Int. Cl. F28D 15/02; B23P 15/26; F28D 15/04

(52) U.S. Cl. CPC F28D 15/0275; F28D 15/04; B23P 15/26

(57) ABSTRACT

A method of manufacturing a heat dissipation device includes: providing a tube, the tube defining a head end, a tail end and a chamber, the head end being closed and the tail end being opened, the chamber being connected outside via the tail end; providing a module for receiving a part of the tube therein, the tail end being positioned out of the module; providing a molding material and injecting the liquid molding material into the module, the molding material being made of metal, a melting point of the molding material being lower than that of the tube; solidifying the molding material to form a base, the part of the tube received and fixed in the tube; removing the module; injecting a working medium into the tube via the tail end; vacuumizing the chamber of the tube; and sealing the tail end of the tube.

### CROSS-REFERENCE TO RELATED APPLICATIONS

This application claims priority to Chinese Patent Application No. 201510247674.6 filed on May 15, 2015, the contents of which are incorporated by reference herein.

### FIELD

The subject matter herein generally relates to a heat dissipation device and a method of manufacturing the heat dissipation device.

### BACKGROUND

In many circumstances, a heat pipe is assembled and fixed with a base by machines or tools, the machines or tools cause deformations or damages in the heat pipe or/and the base.

### BRIEF DESCRIPTION OF THE DRAWINGS

Implementations of the present technology will now be described, by way of example only, with reference to the attached figures.

FIG. 1 is a perspective view of a heat dissipation device in accordance with an exemplary embodiment of the present disclosure.

FIG. 2 is a cross sectional view of the heat dissipation device of FIG. 1, taken along line II-II thereof.

FIG. 3 is a flowchart of a method of manufacturing the heat dissipation device in accordance with an exemplary embodiment of the present disclosure.

FIG. 4 is a perspective view of a tube of the method of manufacturing the heat dissipation device in accordance with an exemplary embodiment of the present disclosure.

FIG. 5 is a cross sectional view of the tube of FIG. 4, taken along line V-V thereof

FIG. 6 is a part cross sectional view of a first end of the tube received in a module of the method of manufacturing the heat dissipation device in accordance with an exemplary embodiment of the present disclosure.

FIG. 7 is a diagrammatic view of the tube assembled with a base of the method of manufacturing the heat dissipation device in accordance with an exemplary embodiment of the present disclosure.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The description is not to be considered as limiting the scope of the embodiments described herein.

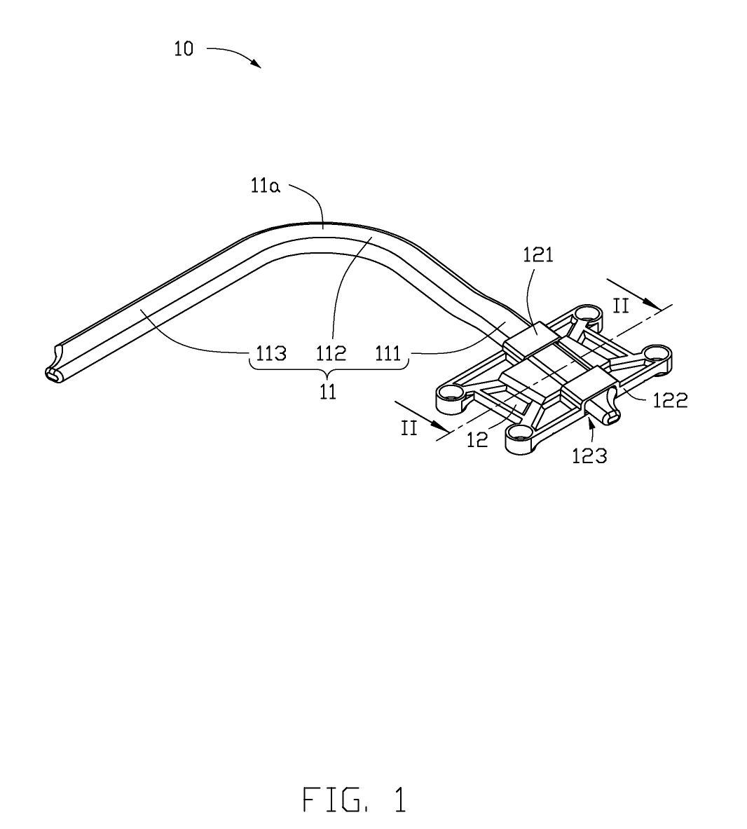

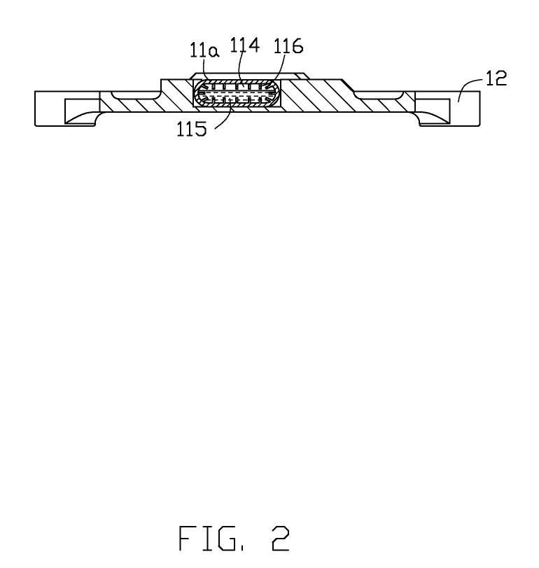

Referring to FIGS. 1-2, a heat dissipation device 10 includes a heat pipe 11 and a base 12. The heat pipe 11 is assembled and fixed in the base 12. The heat pipe 11 directly attaches the base 12. Heat generated from an electrically element (not shown) is conducted to the base 12, and then directly conducted to the heat pipe 11.

The heat pipe 11 includes a pipe body 11a and a working medium 115 sealed in the pipe body 11a. The base 12 and the pipe body 11a are both made of metal. A melting point of the base 12 is lower than that of the pipe body 11a. If the melting point of the base 12 is larger than or equal to that of the pipe body 11a, the pipe body 11a could be melted by a molding material of the base in a method for the heat dissipation device in this application. The pipe body 11a includes a chamber 114. The chamber 114 is partially filled with the liquid working medium 115 accommodated therein, and the remaining space in the chamber 114 is a vacuum or partial vacuum (reduced pressure relative to ambient pressure). The working medium 115 is sealed in the chamber 114. The working medium 115 can be water or alcohol.

The heat pipe 11 has an evaporating section 111, a connecting section 112 and a condensing section 113. The connecting section 112 is connected between the evaporating section 111 and the condensing section 113. The chamber 114 is arranged through the evaporating section 111, the connecting section 112 and the condensing section 113. The evaporating section 111 directly attaches the base 12. The evaporating section 111 is assembled and fixed in the base 12. In at least one embodiment, the heat pipe 11 can be flat. The heat pipe 11 can be a curved structure.

In details, the heat pipe 11 can be an L-shaped structure. The evaporating section 111 can be a linear structure, the condensing section 113 can be a linear structure, and the connecting section 112 can be a curved structure.

The working medium 115 is employed to carry heat, under phase transitions between liquid state and vapor state, from the evaporating section 111 of the heat pipe 11 to the condensing section 113 thereof. In operation, the working medium 115 absorbs heat conducted from the base 12, becomes vaporized and moved away from the evaporating section 111. When the vaporized working medium 115 arrives at the condensing section 113, it condenses back to liquid and releases heat. The condensed working medium 115 is then pumped back to the evaporating section 111. The continuous cycle transfers large quantities of heat conducted from the base 12.

The chamber 114 of the pipe body 11a of the heat pipe 11 can include wick structures 116 received therein. The wick structures 116 can be formed by mesh structures, fibers or particles.

The base 12 includes a fixing portion 121 and a body portion 122. The fixing portion 121 and the body portion 122 define a receiving portion 123. The heat pipe 11 is received and assembled in the receiving portion 123. The fixing portion 121 and the body portion 122 can be a one-piece case. In at least one embodiment, the body portion 122 can be a plate shape. The fixing portion 121 can be a U shaped. A cross sectional view of the receiving portion 123 is a rectangular sharp. The heat pipe 11 can be received and penetrates through the receiving portion 123.

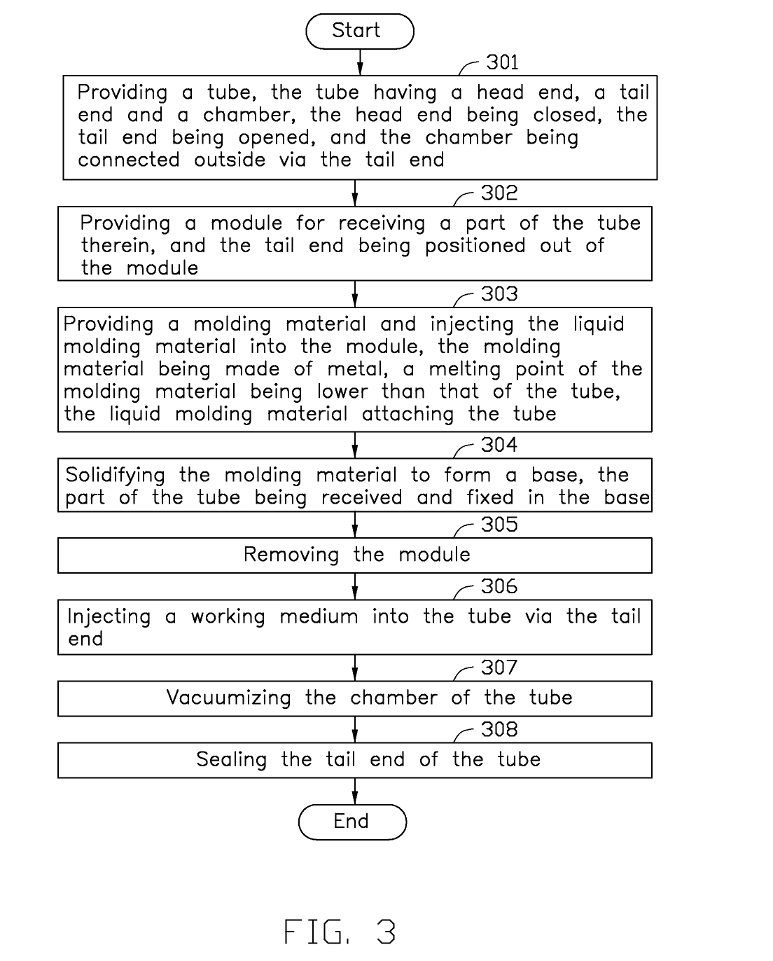

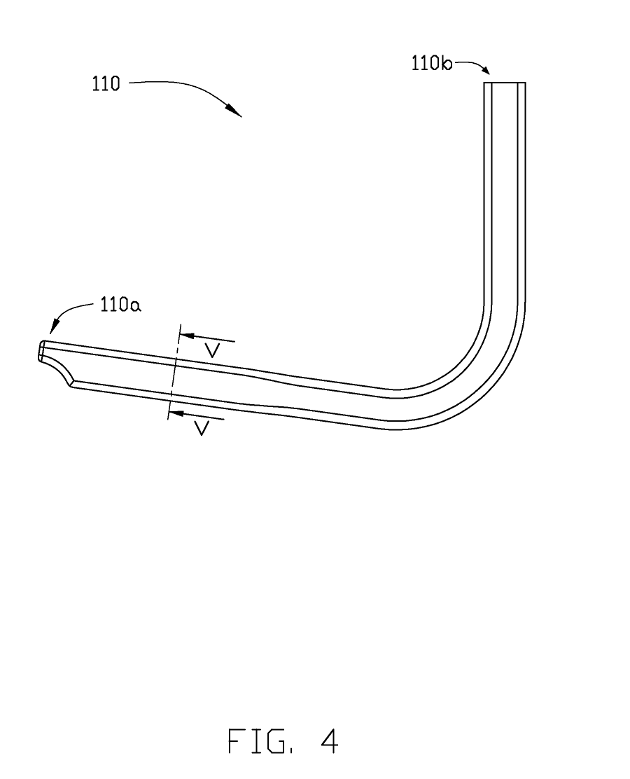

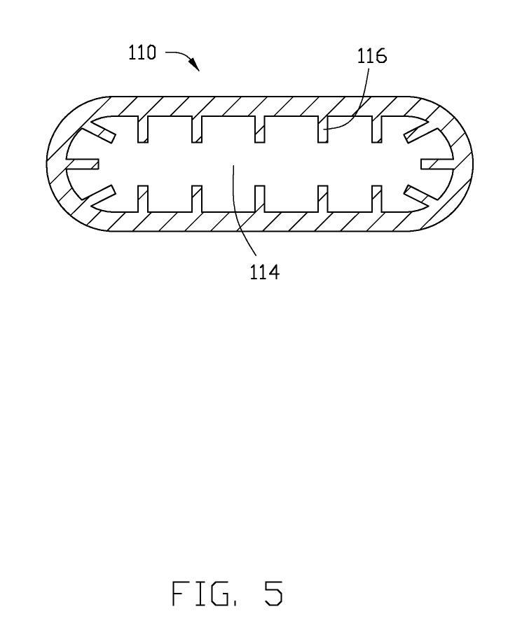

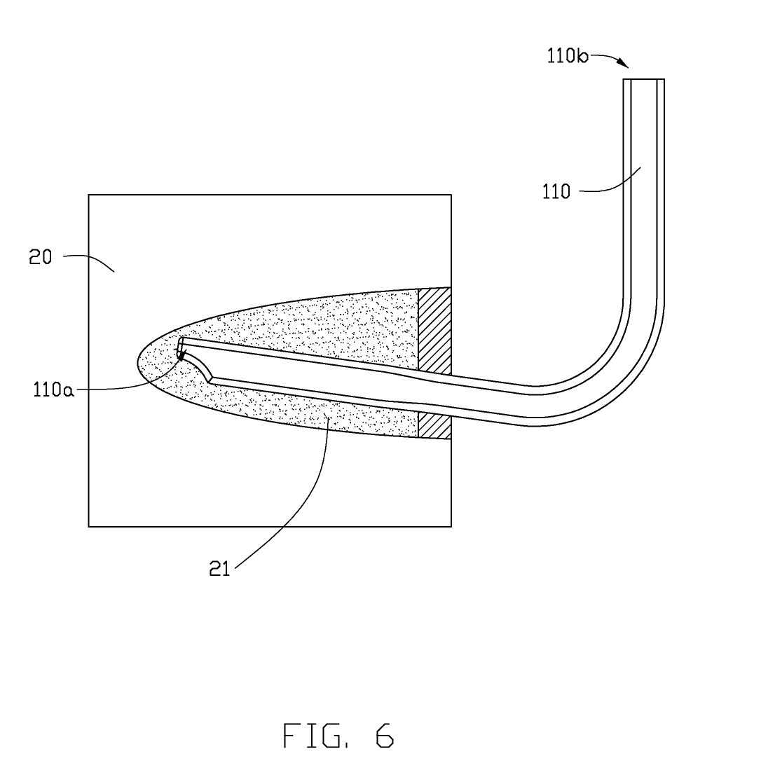

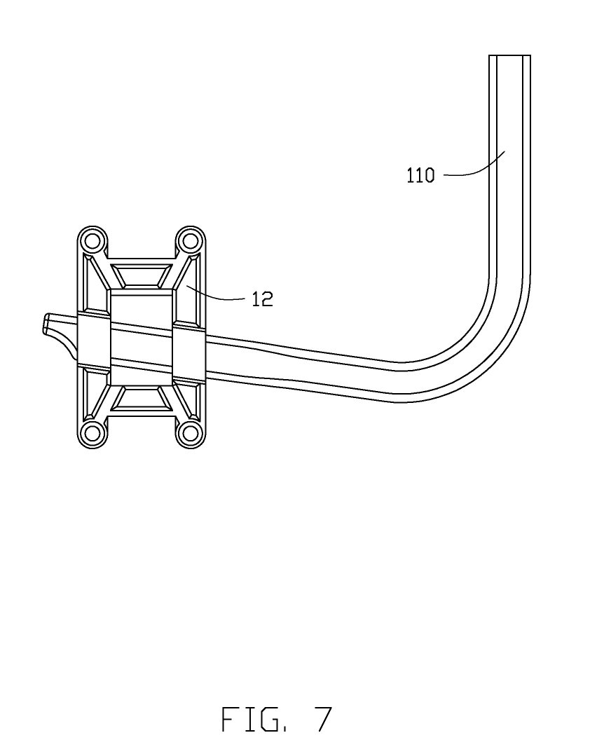

Referring to FIG. 3-7, the present disclosure also provides a method of manufacturing a heat dissipation device 10. The method includes:
in block 301, providing a tube 110, the tube 110 having a head end 110a, a tail end 110b and a chamber 114, the head end 110a being closed, the tail end 110b being opened, and the chamber 114 being connected outside via the tail end 110b;
in block 302, providing a module 20 for receiving a part of the tube 110 therein, and the tail end 110b being positioned out of the module 20;
in block 303, providing a molding material 21 and injecting the liquid molding material 21 into the module 20, the molding material 21 being made of metal, a melting point of the molding material 21 being lower than that of the tube 110, the liquid molding material 21 attaching the tube 110;
in block 304, solidifying the molding material 21 to form a base 12, the part of the tube 110 being received and fixed in the base 12;
in block 305, removing the module 20; in block 306, injecting a working medium 115 into the tube 110 via the tail end 110b;

in block 307, vacuumizing the chamber 114 of the tube 110; and in block 308, sealing the tail end 110b of the tube 110.

In “providing a tube 110, the tube 110 having a head end 110a, a tail end 110b and a chamber 114, the head end 110a being closed, the tail end 110b being opened, and the chamber 114 being connected outside via the tail end 110b”, the method can further include “checking air tightness of the tube 110”. In details, the head end 110a of the tube 110 can be checked its air tightness.

The tube 110 can include wick structures 116 received therein. The wick structures 116 can be formed by mesh structures, fibers or particles.

In this embodiment, the head end 110a of the tube 110 is received in the module 20, and the tail end 110b is positioned out of the module 20. In other embodiments, other parts of the tube 110 can be received in the module 20, and the tail end 110b is positioned out of the module 20.

The working medium 115 can be water or alcohol.

The tube 110 and the molding material 21 can be made of metal. The tube 110 can be made of copper. The molding material 21 can be made of aluminum or copper alloy.

After “removing the module 20”, the base 12 can be treated by a burring process.

After “removing the module 20”, the method can further include “checking air tightness of the tube 110”. In details, the head end 110a of the tube 110 can be checked its air tightness.

The “injecting a working medium 115 into the tube 110 via the tail end 110b” and “vacuumizing the chamber 114 of the tube 110” can be exchanged with each other.

After the tail end 110b of the tube 110 is sealed, the tube 110 is formed to a pipe body 11a of the heat pipe 11, and the tube 110 with the working medium 115 is formed to the heat pipe 11.

In using of the heat dissipation device 10 manufactured by the method, the heat pipe 11 directly attaches the base 12. Heat generated from an electrically element (not shown) is conducted to the base 12, and then directly conducted to the heat pipe 11.

The heat pipe 11 has an evaporating section 111, a connecting section 112 and a condensing section 113. The connecting section 112 is connected between the evaporating section 111 and the condensing section 113. The chamber 114 is arranged through the evaporating section 111, the connecting section 112 and the condensing section 113. The evaporating section 111 directly attaches the base 12. The evaporating section 111 is assembled and fixed in the base 12. In operation, the working medium 115 absorbs heat conducted from the base 12, becomes vaporized and moved away from the evaporating section 111. When the vaporized working medium 115 arrives at the condensing section 113, it condenses back to liquid and releases heat. The condensed working medium 115 is then pumped back to the evaporating section 111. The continuous cycle transfers large quantities of heat conducted from the base 12.

The base 12 includes a fixing portion 121 and a body portion 122. The fixing portion 121 and the body portion 122 define a receiving portion 123. The heat pipe 11 is received and assembled in the receiving portion 123. The fixing portion 121 and the body portion 122 can be a one-piece case. In at least one embodiment, the body portion 122 can be a plate shape. The fixing portion 121 can be a U-shaped structure. A cross sectional view of the receiving portion 123 is a rectangular. The heat pipe 11 can be received and penetrates through the receiving portion 123.

It is to be further understood that even though numerous characteristics and advantages have been set forth in the foregoing description of embodiments, together with details of the structures and functions of the embodiments, the disclosure is illustrative only; and that changes may be made in detail, including in matters of shape, size, and arrangement of parts within the principles of the disclosure to the full extent indicated by the broad general meaning of the terms in which the appended claims are expressed.

What is claimed is:

1. A heat dissipation device comprising:
a base made of metal; and
a heat pipe made of metal and comprising a pipe body and a working medium sealed in the pipe body, the heat pipe directly attaches, being assembled and fixed in the base, and a melting point of the base being lower than that of the pipe body.

2. The heat dissipation device of claim 1, wherein the pipe body comprises a chamber, the working medium is sealed in the chamber.

3. The heat dissipation device of claim 2, wherein the heat pipe has an evaporating section, a connecting section and a condensing section, the connecting section is connected between the evaporating section and the condensing section, and the chamber is arranged through the evaporating section, the connecting section and the condensing section.

4. The heat dissipation device of claim 3, wherein the evaporating section directly attaches the base, the evaporating section is assembled and fixed in the base.

5. The heat dissipation device of claim 2, wherein the chamber of the pipe body of the heat pipe comprises wick structures received therein.

6. The heat dissipation device of claim 5, wherein the wick structures are formed by mesh structures, fibers or particles.

7. The heat dissipation device of claim 1, wherein the base comprises a fixing portion and a body portion, the fixing portion and the body portion define a receiving portion, the heat pipe is received and assembled in the receiving portion.

8. The heat dissipation device of claim 7, wherein the heat pipe is received and penetrates through the receiving portion.

9. A method of manufacturing a heat dissipation device, comprising:
providing a tube, the tube having a head end, a tail end and a chamber, the head end being closed, the tail end being opened, and the chamber being connected outside via the tail end;
providing a module for receiving a part of the tube therein, and the tail end being positioned out of the module;
providing a molding material and injecting the liquid molding material into the module, the molding material being made of metal, a melting point of the molding material being lower than that of the tube, the liquid molding material attaching the tube;
solidifying the molding material to form a base, the part of the tube being received and fixed in the base;
removing the module;
injecting a working medium into the tube via the tail end;
vacuumizing the chamber of the tube; and
sealing the tail end of the tube.

10. The method of claim 9, wherein the tube comprises wick structures received therein.

11. The method of claim 10, wherein the wick structures are formed by mesh structures, fibers or particles.

12. The method of claim 9, wherein the tube is made of copper, the molding material is made of aluminum or copper alloy.

13. The method of claim 9, wherein after “removing the module”, the base is treated by a burring process.

14. The method of claim 9 further comprises “checking air tightness of the tube” after “removing the module”.

15. The method of claim 9, wherein “injecting a working medium into the tube via the tail end” and “vacuumizing the chamber of the tube” is exchanged with each other.

16. A heat dissipation device comprising:
a base configured to be attached to a heat generating component; and
an elongated heat pipe having a first end, a second end, and a curved section between the first and second end, the heat pipe defining a sealed interior chamber containing a working fluid and a space of reduced pressure, the heat pipe being connected to the base proximate to the first end;
wherein when the base absorbs heat from a heat generating component, the heat travels through the base to the heat pipe to vaporize working fluid within the heat pipe proximate to the base, and the vaporized working fluid travels to and condenses at the second end of the heat pipe.
